(19) United States
(12) Patent Application Publication
(10) Pub. No.: US 2026/0329698 A1
(43) Pub. Date: Oct. 22, 2026

(54) Survivability-Oriented Runtime Continuity Architecture

(71) Applicant: Xinxin Shan, Surrey (CA)

(72) Inventor: Xinxin Shan, Surrey (CA)

(73) Assignee: LED Smart Inc, Surrey (CA)

(21) Appl. No.: 19/697,452

(22) Filed: Jun. 3, 2026

(51) Int. Cl. G06F 11/14

(52) U.S. Cl. CPC G06F 11/1438

(57) ABSTRACT

A survivability-oriented runtime continuity architecture configured to preserve continuity-preserving runtime participation across degraded runtime participation conditions, fragmented distributed runtime participation environments, heterogeneous runtime participation infrastructures, and reconstructable runtime participation conditions. The disclosed structures preserve continuity-preserving runtime participation through continuity-governed survivability inheritance relationships rather than unrestricted probabilistic runtime regeneration relationships. The disclosed architecture further provides distributed continuity governance relationships, continuity collapse prevention relationships, reconstructable survivability restoration relationships, authoritative continuity inheritance determination relationships, anchored continuity preservation relationships, and probabilistic runtime participation subordination relationships operating together as unified survivability-governed runtime continuity infrastructures. Generated runtime participation states do not become continuity-preserving runtime participation states unless continuity-governed survivability admissibility relationships are satisfied prior to operational participation.

### CROSS-REFERENCE TO RELATED APPLICATIONS

This application claims the benefit of and priority to all applicable provisional applications, non-provisional applications, continuation applications, continuation-in-part applications, divisional applications, foreign applications, international applications, and all other related applications owned by the applicant and associated with survivability-oriented runtime continuity architectures, continuity-governed runtime participation architectures, authoritative continuity inheritance architectures, continuity-preserving runtime participation infrastructures, probabilistic runtime participation subordination architectures, reconstructable survivability architectures, distributed runtime participation continuity architectures, continuity collapse prevention architectures, runtime continuity inheritance architectures, and future equivalent continuity-governed survivability infrastructures.

### PRIOR ART

The references listed below correspond to publicly available patent documents.

The inclusion of any reference herein is not an admission that such reference is material to patentability, is relevant to the claimed subject matter, or constitutes prior art against the present disclosure.

None of the listed references is believed to disclose or render obvious a survivability-governed runtime continuity architecture in which continuity-preserving runtime participation existence is continuity-inherited from previously admitted continuity-preserving runtime participation states associated with authoritative continuity inheritance relationships while probabilistic runtime participation generation operates as bounded non-authoritative runtime participation candidate generation beneath continuity-governed survivability inheritance determination relationships.

None of the listed references is believed to disclose or render obvious a continuity authority governance architecture in which authoritative continuity inheritance structures govern admissibility associated with continuity-preserving runtime participation continuity across degraded runtime participation conditions, fragmented distributed runtime participation environments, reconstructable survivability restoration conditions, and heterogeneous runtime participation infrastructures.

None of the listed references is believed to disclose or render obvious a survivability-oriented runtime continuity architecture in which reconstructable runtime participation continuity remains subordinated beneath continuity-governed survivability admissibility relationships and authoritative continuity inheritance relationships rather than unrestricted probabilistic runtime regeneration relationships.

### U.S. PATENT DOCUMENTS

U.S. Pat. No. 6014669A January 2000 Slaughter et al.
U.S. Pat. No. 8,554,981 B2 October 2013 Schmidt et al.
U.S. Pat. No. 8,880,941 B1 November 2014 Reiss et al.
U.S. Pat. No. 11,429,379 B2 August 2022 Jain et al.
U.S. Pat. No. 7,801,852 B2 September 2010 Wong et al.
U.S. Pat. No. 10,901,957 B2 January 2021 Natarajan et al.
U.S. Pat. No. 8,135,987 B2 March 2012 Douceur et al.
U.S. Pat. No. 10,460,130 B1 October 2019 Chhabra
U.S. Pat. No. 9,448,927 B1 September 2016 Agarwala et al.
U.S. Pat. No. 9,965,203 B1 May 2018 Agarwala et al.
U.S. Pat. No. 11,954,220 B2 April 2024 Ekins
U.S. Pat. No. 12,461,695 B2 November 2025 Mitkar et al.
U.S. Pat. No. 12,450,126 B2 October 2025 Nanjundappa et al.
U.S. Pat. No. 9,882,833 B2 January 2018 Mcbride et al.
U.S. Pat. No. 10,862,822 B2 December 2020 Bugenhagen et al.
U.S. Pat. No. 10,203,701 B2 February 2019 Kurdi et al.
U.S. Pat. No. 2021/0319340 A1 October 2021 Shabtay et al.
U.S. Pat. No. 2018/0330238 A1 October 2018 Luciw et al.
U.S. Pat. No. 11,615,331 B2 March 2023 Li et al.

### BACKGROUND OF THE INVENTION

Conventional runtime continuity infrastructures frequently depend upon unrestricted probabilistic runtime regeneration, unrestricted orchestration continuity propagation, unrestricted replay continuity, unrestricted failover continuity, unrestricted checkpoint restoration, unrestricted synchronization propagation, or unrestricted distributed persistence relationships to preserve operational continuity across distributed runtime participation environments.

However, such infrastructures may generate continuity fragmentation, probabilistic drift, runtime participation divergence, operational instability, continuity collapse, synchronization inconsistency, distributed operational fragmentation, survivability degradation, or operational discontinuity during degraded runtime participation conditions, fragmented communication environments, heterogeneous runtime participation infrastructures, disconnected operational environments, or probabilistically unstable runtime participation conditions.

Additionally, conventional runtime continuity infrastructures frequently permit generated probabilistic runtime participation states to independently influence runtime participation continuity determination without authoritative continuity inheritance governance relationships. Such unrestricted probabilistic runtime regeneration may therefore generate continuity inconsistency, runtime participation instability, operational divergence, or fragmented runtime participation continuity.

Accordingly, improved survivability-oriented runtime continuity architectures capable of preserving continuity-preserving runtime participation through continuity-governed survivability inheritance relationships remain desirable.

### SUMMARY OF THE INVENTION

The present disclosure provides survivability-oriented runtime continuity architectures configured to preserve continuity-preserving runtime participation across degraded runtime participation conditions, fragmented distributed runtime participation environments, heterogeneous runtime participation infrastructures, runtime participation contraction conditions, survivability-preserving runtime participation conditions, and reconstructable continuity-preserving runtime participation conditions.

The disclosed structures preserve continuity-preserving runtime participation through continuity-governed survivability inheritance relationships rather than unrestricted probabilistic runtime regeneration relationships.

The disclosed structures further provide distributed continuity governance relationships, continuity collapse prevention relationships, reconstructable survivability restoration relationships, authoritative continuity inheritance determination relationships, anchored continuity preservation relationships, probabilistic runtime participation subordination relationships, contradiction-governed runtime participation relationships, synchronization-governed runtime continuity relationships, distributed survivability federation relationships, and continuity-preserving operational restoration relationships operating together as unified survivability-governed runtime continuity infrastructures.

Generated runtime participation states do not become continuity-preserving runtime participation states unless continuity-governed survivability admissibility relationships are satisfied prior to operational participation.

Authoritative continuity inheritance structures govern admissibility associated with continuity-preserving runtime participation continuity.

Probabilistic runtime participation generation remains non-authoritative with respect to continuity-preserving runtime participation existence determination.

Continuity-preserving runtime participation continuity is inherited from previously admitted continuity-preserving runtime participation states associated with authoritative continuity inheritance relationships rather than unrestricted probabilistic runtime regeneration.

### BRIEF DESCRIPTION OF DRAWINGS

FIG. 1—Survivability-Oriented Runtime Continuity Architecture

FIG. 2—Distributed Runtime Participation Continuity Architecture

FIG. 3—Continuity Inheritance Governance Architecture

FIG. 4—Probabilistic Runtime Participation Subordination Architecture

FIG. 5—Continuity Collapse Prevention Architecture

FIG. 6—Reconstructable Survivability Restoration Architecture

FIG. 7—Anchored Continuity Preservation Architecture

FIG. 8—Survivability-Governed Runtime Participation Ecology Architecture

### DETAILED DESCRIPTION OF THE INVENTION

The following figures describe survivability-oriented runtime continuity structures associated with continuity-preserving runtime participation, distributed continuity governance, continuity collapse prevention, runtime continuity inheritance, reconstructable survivability restoration, authoritative continuity inheritance determination, anchored continuity preservation, probabilistic runtime participation subordination, fragmented distributed runtime participation continuity, heterogeneous runtime participation continuity, runtime participation contraction continuity, survivability-preserving runtime participation continuity, and continuity-governed survivability inheritance architectures operating together as unified survivability-governed runtime continuity infrastructures.

The disclosed structures are constitutional runtime continuity structures and are not limited to any particular software implementation, hardware implementation, firmware implementation, orchestration implementation, probabilistic implementation, artificial intelligence implementation, distributed runtime implementation, communication carrier implementation, cloud infrastructure implementation, edge runtime implementation, container implementation, virtualized infrastructure implementation, operating system implementation, persistence implementation, replay implementation, checkpoint implementation, failover implementation, or future equivalent runtime participation technology.

The disclosed structures do not describe unrestricted autonomous intelligence architectures, unrestricted recursive self-expansion architectures, unrestricted probabilistic runtime regeneration architectures, unrestricted orchestration continuity architectures, unrestricted runtime replay architectures, unrestricted failover continuity architectures, unrestricted distributed persistence architectures, unrestricted checkpoint restoration architectures, unrestricted autonomous artificial intelligence civilizations, consciousness systems, or self-aware intelligence systems.

The illustrated structures operate together as unified survivability-governed runtime continuity inheritance architectures configured to preserve continuity-preserving runtime participation across degraded runtime participation conditions, fragmented distributed runtime participation environments, heterogeneous runtime participation infrastructures, runtime participation contraction conditions, survivability-preserving runtime participation conditions, reconstructable continuity-preserving runtime participation conditions, and continuity-governed runtime participation environments.

Generated runtime participation does not become continuity-preserving runtime participation unless governed according to authoritative continuity inheritance structures associated with survivability-governed runtime participation continuity.

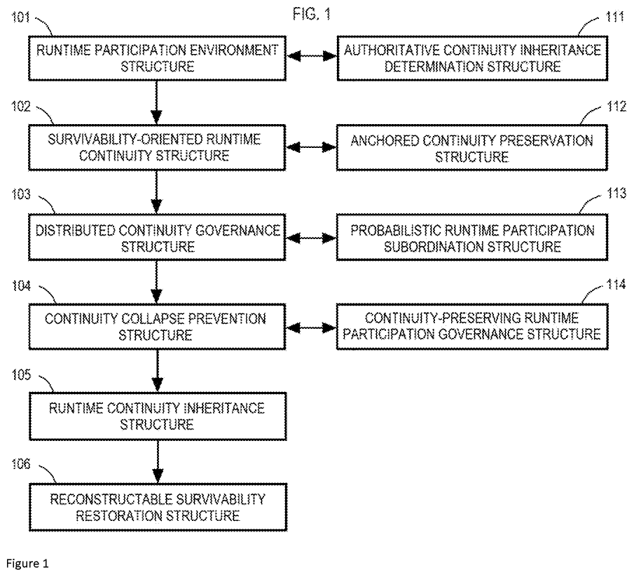

FIG. 1 illustrates a survivability-oriented runtime continuity architecture in which continuity-preserving runtime participation is maintained through continuity-governed survivability inheritance relationships operating across degraded runtime participation conditions. The figure includes a runtime participation environment structure 101, a survivability-oriented runtime continuity structure 102, a distributed continuity governance structure 103, a continuity collapse prevention structure 104, a runtime continuity inheritance structure 105, and a reconstructable survivability restoration structure 106 operating together with an authoritative continuity inheritance determination structure 111, an anchored continuity preservation structure 112, a probabilistic runtime participation subordination structure 113, and a continuity-preserving runtime participation governance structure 114. The illustrated structures operate together such that continuity-preserving runtime participation is maintained through continuity-governed survivability inheritance rather than unrestricted probabilistic runtime regeneration.

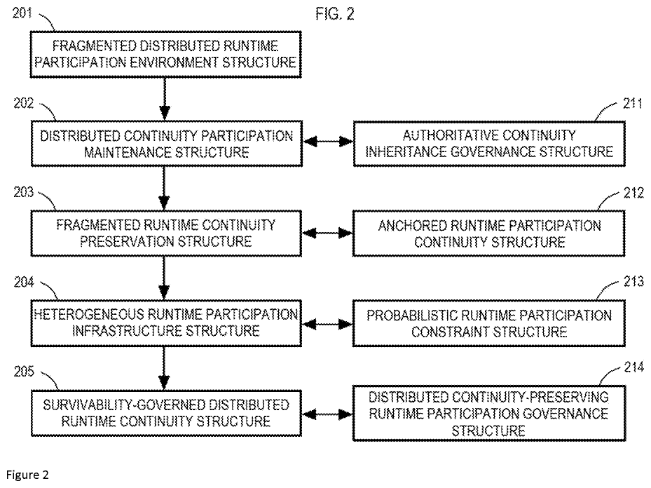

FIG. 2 illustrates a distributed runtime participation continuity architecture in which fragmented distributed runtime participation environments remain continuity-governed through authoritative continuity inheritance relationships. The figure includes a fragmented distributed runtime participation environment structure 201, a distributed continuity participation maintenance structure 202, a fragmented runtime continuity preservation structure 203, a heterogeneous runtime participation infrastructure structure 204, and a survivability-governed distributed runtime continuity structure 205 operating together with an authoritative continuity inheritance governance structure 211, an anchored runtime participation continuity structure 212, a probabilistic runtime participation constraint structure 213, and a distributed continuity-preserving runtime participation governance structure 214. The illustrated structures operate together such that distributed runtime participation continuity remains continuity-governed across fragmented distributed runtime participation environments.

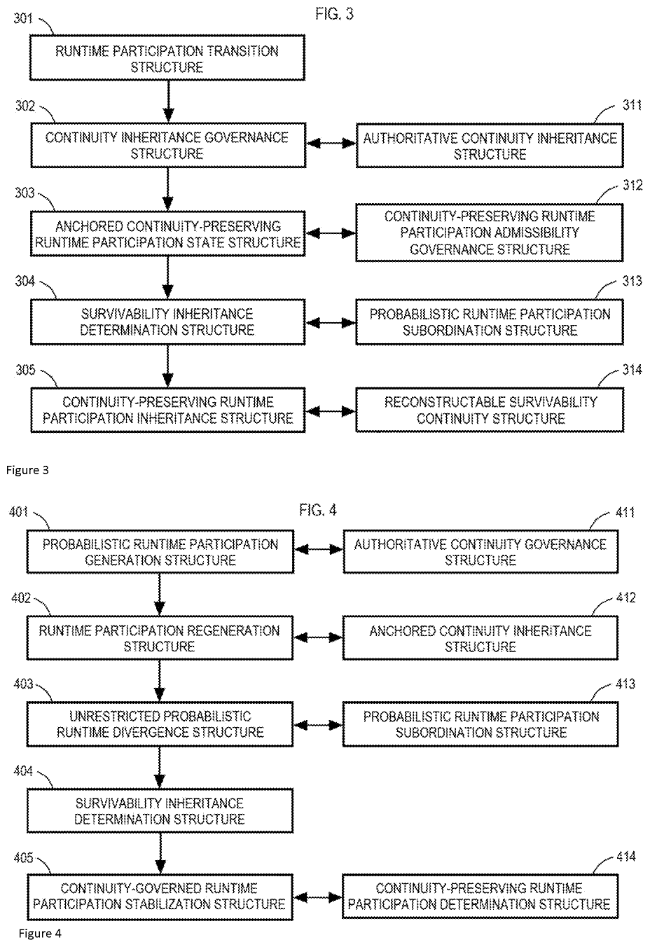

FIG. 3 illustrates a continuity inheritance governance architecture in which continuity-preserving runtime participation is inherited from anchored continuity-preserving runtime participation states operating as authoritative survivability inheritance structures. The figure includes a runtime participation transition structure 301, a continuity inheritance governance structure 302, an anchored continuity-preserving runtime participation state structure 303, a survivability inheritance determination structure 304, and a continuity-preserving runtime participation inheritance structure 305 operating together with an authoritative continuity inheritance structure 311, a continuity-preserving runtime participation admissibility governance structure 312, a probabilistic runtime participation subordination structure 313, and a reconstructable survivability continuity structure 314. The illustrated structures operate together such that authoritative continuity inheritance structures govern admissibility of continuity-preserving runtime participation.

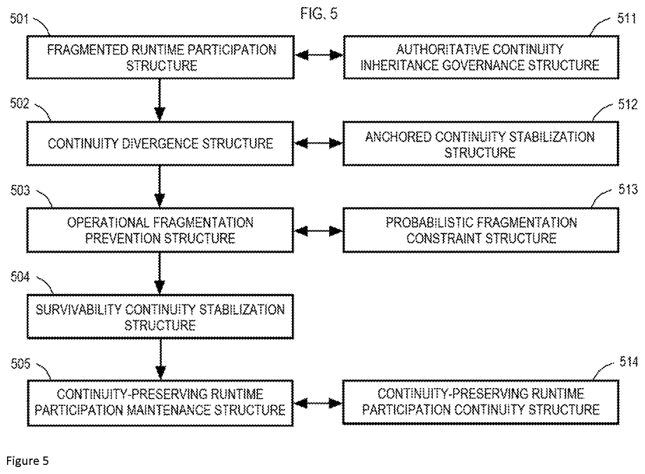

FIG. 4 illustrates a probabilistic runtime participation subordination architecture in which unrestricted probabilistic runtime participation regeneration remains subordinated beneath continuity-governed survivability inheritance determination. The figure includes a probabilistic runtime participation generation structure 401, a runtime participation regeneration structure 402, an unrestricted probabilistic runtime divergence structure 403, a survivability inheritance determination structure 404, and a continuity-governed runtime participation stabilization structure 405 operating together with an authoritative continuity governance structure 411, an anchored continuity inheritance structure 412, a probabilistic runtime participation subordination structure 413, and a continuity-preserving runtime participation determination structure 414. The illustrated structures operate together such that unrestricted probabilistic runtime participation regeneration remains subordinate to continuity-governed survivability inheritance determination.

FIG. 5 illustrates a continuity collapse prevention architecture in which operational fragmentation associated with unrestricted probabilistic runtime recomputation is constrained through continuity-governed survivability continuity preservation. The figure includes a fragmented runtime participation structure 501, a continuity divergence structure 502, an operational fragmentation prevention structure 503, a survivability continuity stabilization structure 504, and a continuity-preserving runtime participation maintenance structure 505 operating together with an authoritative continuity inheritance governance structure 511, an anchored continuity stabilization structure 512, a probabilistic fragmentation constraint structure 513, and a continuity-preserving runtime participation continuity structure 514. The illustrated structures operate together such that continuity collapse prevention constrains unrestricted probabilistic runtime participation divergence associated with fragmented distributed runtime participation environments.

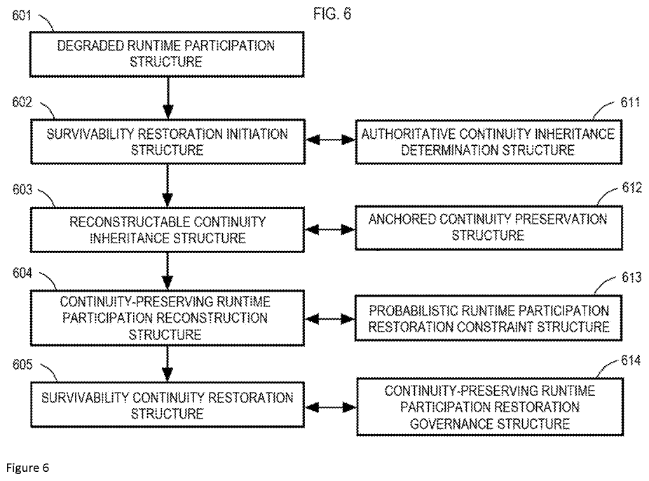

FIG. 6 illustrates a reconstructable survivability restoration architecture in which continuity-preserving runtime participation is reconstructed from previously admitted continuity-governed runtime participation structures. The figure includes a degraded runtime participation structure 601, a survivability restoration initiation structure 602, a reconstructable continuity inheritance structure 603, a continuity-preserving runtime participation reconstruction structure 604, and a survivability continuity restoration structure 605 operating together with an authoritative continuity inheritance determination structure 611, an anchored continuity preservation structure 612, a probabilistic runtime participation restoration constraint structure 613, and a continuity-preserving runtime participation restoration governance structure 614. The illustrated structures operate together such that reconstructable survivability restoration maintains continuity-preserving runtime participation across degraded runtime participation conditions.

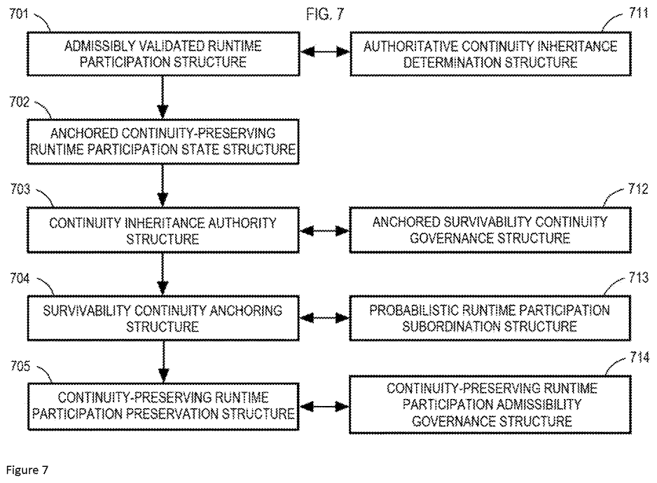

FIG. 7 illustrates an anchored continuity preservation architecture in which admissibly validated continuity-preserving runtime participation states are maintained as authoritative continuity inheritance structures. The figure includes an admissibly validated runtime participation structure 701, an anchored continuity-preserving runtime participation state structure 702, a continuity inheritance authority structure 703, a survivability continuity anchoring structure 704, and a continuity-preserving runtime participation preservation structure 705 operating together with an authoritative continuity inheritance determination structure 711, an anchored survivability continuity governance structure 712, a probabilistic runtime participation subordination structure 713, and a continuity-preserving runtime participation admissibility governance structure 714. The illustrated structures operate together such that authoritative continuity inheritance structures govern admissibility of continuity-preserving runtime participation.

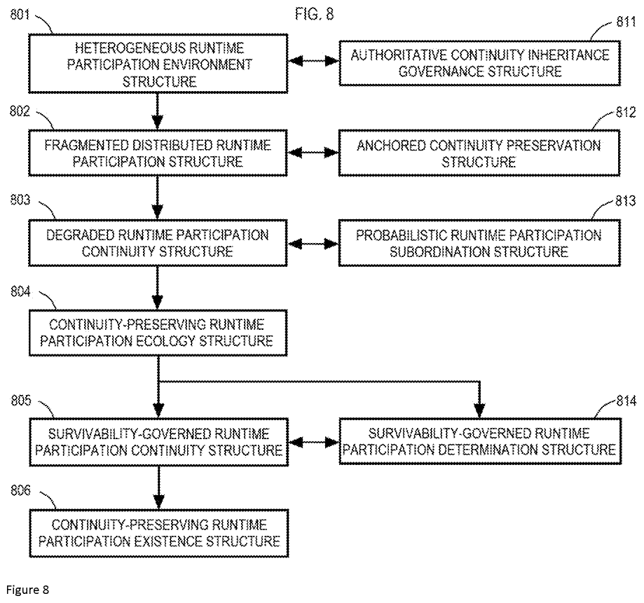

FIG. 8 illustrates a survivability-governed runtime participation ecology architecture in which continuity-preserving runtime participation is maintained across heterogeneous distributed runtime participation environments through continuity-governed survivability inheritance relationships. The figure includes a heterogeneous runtime participation environment structure 801, a fragmented distributed runtime participation structure 802, a degraded runtime participation continuity structure 803, a continuity-preserving runtime participation ecology structure 804, a survivability-governed runtime participation continuity structure 805, and a continuity-preserving runtime participation existence structure 806 operating together with an authoritative continuity inheritance governance structure 811, an anchored continuity preservation structure 812, a probabilistic runtime participation subordination structure 813, and a survivability-governed runtime participation determination structure 814. The illustrated structures operate together such that continuity-preserving runtime participation remains continuity-governed across heterogeneous distributed runtime participation environments and degraded runtime participation conditions.

The following description provides detailed support for survivability-oriented runtime continuity structures associated with continuity-preserving runtime participation, distributed continuity governance, continuity collapse prevention, runtime continuity inheritance, reconstructable survivability restoration, authoritative continuity inheritance determination, anchored continuity preservation, probabilistic runtime participation subordination, fragmented distributed runtime participation continuity, heterogeneous runtime participation continuity, runtime participation contraction continuity, survivability-preserving runtime participation continuity, continuity-governed survivability lineage preservation, runtime continuity reconstruction governance, contradiction-governed runtime participation continuity, distributed survivability federation continuity, partial operational survivability continuity, degraded runtime participation survivability continuity, runtime continuity synchronization governance, continuity-preserving operational restoration, and continuity-governed survivability inheritance architectures operating together as unified survivability-governed runtime continuity infrastructures.

The disclosed structures are constitutional survivability-oriented runtime continuity structures and are not limited to any particular software implementation, hardware implementation, firmware implementation, orchestration implementation, artificial intelligence implementation, probabilistic implementation, distributed infrastructure implementation, communication implementation, cloud infrastructure implementation, edge runtime implementation, persistence implementation, replay implementation, failover implementation, checkpoint implementation, virtualization implementation, operating system implementation, container implementation, sensor implementation, autonomous infrastructure implementation, transportation implementation, maritime implementation, industrial implementation, military implementation, drone implementation, mesh implementation, multi-bearer implementation, or future equivalent runtime participation technology.

The disclosed structures do not describe unrestricted autonomous intelligence systems, unrestricted probabilistic runtime regeneration systems, unrestricted recursive self-modification systems, unrestricted self-governing machine civilizations, unrestricted autonomous orchestration systems, unrestricted self-authorizing runtime systems, unrestricted probabilistic operational continuity determination systems, or unrestricted runtime existence generation systems.

Generated runtime participation states may be produced by artificial intelligence systems, deterministic systems, probabilistic systems, distributed systems, firmware systems, hardware systems, sensor systems, communication systems, external operational systems, human-authorized systems, machine-assisted systems, edge runtime systems, cloud systems, heterogeneous runtime systems, distributed runtime infrastructures, degraded runtime infrastructures, military operational infrastructures, maritime operational infrastructures, transportation operational infrastructures, industrial operational infrastructures, drone operational infrastructures, or future equivalent systems, but generated runtime participation states do not become continuity-preserving runtime participation unless continuity-governed survivability admissibility relationships are satisfied.

Generated runtime participation states do not become operationally existent continuity-preserving runtime participation states unless continuity-governed survivability admissibility relationships are satisfied prior to operational participation.

Generated runtime participation states remain non-participatory unless continuity-governed survivability admissibility relationships are satisfied.

Continuity-preserving runtime participation existence is governance-conditioned rather than generation-conditioned.

Continuity-preserving runtime participation continuity is inherited from previously admitted continuity-preserving runtime participation states associated with authoritative continuity inheritance relationships rather than unrestricted probabilistic runtime regeneration.

Continuity-preserving runtime participation existence is inherited from previously admitted continuity-preserving runtime participation states.

Authoritative continuity inheritance structures govern admissibility associated with continuity-preserving runtime participation continuity.

Authoritative continuity inheritance relationships govern continuity-preserving runtime participation existence precedence.

Probabilistic runtime participation generation may assist survivability-oriented runtime continuity reconstruction, but unrestricted probabilistic runtime regeneration does not independently determine continuity-preserving runtime participation existence.

Probabilistic runtime participation generation remains non-authoritative with respect to continuity-preserving runtime participation existence determination.

The disclosed survivability-oriented runtime continuity structures preserve continuity-governed operational survivability across runtime degradation conditions through continuity inheritance relationships, survivability-preserving reconstruction relationships, authoritative continuity anchoring relationships, distributed continuity governance relationships, continuity contraction governance relationships, survivability lineage relationships, contradiction-governed runtime participation relationships, and distributed survivability federation relationships.

Operational survivability continuity is preserved through continuity inheritance relationships rather than unrestricted operational regeneration relationships.

A survivability-oriented runtime continuity infrastructure may comprise one or more runtime participation infrastructures configured to receive generated runtime participation states originating from distributed runtime participation environments, heterogeneous runtime participation infrastructures, probabilistic runtime participation environments, sensor infrastructures, communication infrastructures, firmware infrastructures, hardware infrastructures, artificial intelligence infrastructures, external operational infrastructures, military operational infrastructures, maritime operational infrastructures, transportation operational infrastructures, drone operational infrastructures, industrial operational infrastructures, edge operational infrastructures, or future equivalent runtime participation environments.

Generated runtime participation states may comprise operational participation states, communication participation states, distributed runtime participation states, sensor participation states, probabilistic runtime participation states, continuity reconstruction states, runtime survivability states, lineage-associated runtime participation states, distributed governance states, synchronization-governed runtime continuity states, degradation-associated runtime participation states, continuity contraction states, fragmented operational continuity states, or future equivalent runtime participation structures.

A continuity-governed survivability admissibility infrastructure may determine whether generated runtime participation states satisfy continuity-governed survivability admissibility relationships associated with continuity-preserving runtime participation continuity.

Continuity-governed survivability admissibility relationships may comprise continuity inheritance relationships, authoritative continuity inheritance relationships, survivability lineage relationships, distributed continuity governance relationships, runtime continuity consistency relationships, operational survivability relationships, continuity anchoring relationships, admissibility-preserving runtime continuity relationships, contradiction-governed runtime participation relationships, synchronization-governed continuity relationships, operational reconstruction admissibility relationships, continuity contraction governance relationships, distributed survivability federation relationships, or future equivalent continuity-governed survivability relationships.

Generated runtime participation states failing continuity-governed survivability admissibility relationships are prevented from becoming continuity-preserving runtime participation states.

Generated runtime participation states satisfying continuity-governed survivability admissibility relationships may become continuity-preserving runtime participation states associated with survivability-preserving runtime continuity.

Continuity-preserving runtime participation states may be preserved within continuity-governed survivability inheritance infrastructures configured to maintain continuity-preserving runtime participation continuity across degraded runtime participation environments, fragmented runtime participation environments, heterogeneous runtime participation infrastructures, probabilistic runtime participation environments, distributed operational environments, disconnected communication environments, military operational environments, maritime operational environments, transportation operational environments, industrial operational environments, drone operational environments, runtime participation contraction environments, or future equivalent survivability-oriented runtime participation environments.

A distributed continuity governance infrastructure may govern continuity-preserving runtime participation continuity across fragmented distributed runtime participation infrastructures.

Distributed runtime participation infrastructures may operate across partially degraded communication environments, disconnected runtime participation environments, fragmented operational environments, probabilistically unstable environments, heterogeneous runtime participation environments, mobile runtime participation environments, maritime runtime participation environments, transportation runtime participation environments, industrial runtime participation environments, autonomous runtime participation environments, cloud runtime participation environments, edge runtime participation environments, mesh runtime participation environments, multi-bearer runtime participation environments, or future equivalent survivability-oriented runtime participation environments.

Distributed continuity governance relationships preserve continuity-preserving runtime participation continuity through continuity inheritance relationships associated with previously admitted continuity-preserving runtime participation states rather than unrestricted probabilistic synchronization relationships.

Continuity-preserving runtime participation continuity is not determined through unrestricted synchronization propagation.

Distributed continuity-preserving runtime participation continuity may persist without unrestricted distributed consensus propagation.

Distributed runtime participation continuity may persist despite partial infrastructure degradation or partial operational isolation.

Continuity-preserving runtime participation continuity may remain operationally survivable even when portions of distributed runtime participation infrastructures become degraded, disconnected, partially unavailable, communication-constrained, probabilistically unstable, operationally fragmented, partially reconstructed, or temporarily non-participatory.

A continuity collapse prevention infrastructure may constrain unrestricted probabilistic runtime participation regeneration from independently determining continuity-preserving runtime participation existence.

Unrestricted probabilistic runtime participation regeneration may otherwise generate runtime participation divergence, continuity fragmentation, operational instability, probabilistic drift, identity inconsistency, survivability degradation, continuity fragmentation propagation, distributed runtime instability, synchronization collapse, continuity inheritance inconsistency, distributed operational collapse, or runtime continuity collapse.

Generated runtime participation states therefore remain subordinated beneath continuity-governed survivability admissibility relationships, authoritative continuity inheritance relationships, anchored continuity-preserving runtime participation relationships, and continuity-governed survivability lineage relationships.

A runtime continuity inheritance infrastructure may preserve continuity-preserving runtime participation continuity across runtime participation transitions, survivability-preserving runtime reconstruction events, distributed runtime participation environments, degraded operational conditions, fragmented communication environments, runtime participation contraction environments, distributed survivability redistribution conditions, infrastructure migration conditions, operational replacement conditions, heterogeneous runtime transitions, or future equivalent survivability-oriented runtime participation conditions.

Continuity-preserving runtime participation states may inherit continuity-preserving runtime participation continuity from previously admitted continuity-preserving runtime participation states associated with authoritative continuity inheritance relationships.

A survivability-preserving reconstruction infrastructure may reconstruct admissibly inherited continuity-preserving runtime participation states from previously admitted continuity-preserving runtime participation states preserved within continuity-governed survivability inheritance infrastructures.

Reconstruction relationships preserve continuity-preserving runtime participation continuity through survivability-governed continuity inheritance relationships rather than unrestricted probabilistic runtime regeneration relationships.

Reconstructed runtime participation states inherit survivability continuity from previously admitted continuity-preserving runtime participation states rather than independently generating continuity-preserving runtime participation existence.

Reconstruction does not independently establish continuity-preserving runtime participation existence.

Reconstructed runtime participation states remain subject to continuity-governed survivability admissibility determination relationships before becoming continuity-preserving runtime participation states.

An authoritative continuity inheritance infrastructure may determine authoritative continuity inheritance relationships associated with survivability-preserving runtime continuity.

An anchored continuity preservation infrastructure may preserve authoritative continuity inheritance structures as anchored continuity-preserving runtime participation states associated with survivability-preserving runtime continuity.

Anchored continuity-preserving runtime participation states may operate as authoritative survivability inheritance references associated with continuity-preserving runtime participation continuity determination.

A contradiction-governed runtime participation infrastructure may constrain contradictory runtime participation states from becoming continuity-preserving runtime participation states when contradictory runtime participation states conflict with authoritative continuity inheritance relationships.

Contradictory runtime participation states are prevented from independently superseding authoritative continuity inheritance relationships.

Contradictory runtime participation states may comprise inconsistent operational participation states, conflicting distributed runtime participation states, probabilistically divergent runtime participation states, synchronization-inconsistent runtime participation states, operationally conflicting runtime participation states, continuity-fragmenting runtime participation states, or future equivalent contradictory runtime participation structures.

A runtime participation contraction continuity infrastructure may preserve continuity-preserving runtime participation continuity during runtime participation contraction conditions associated with communication degradation, infrastructure reduction, distributed fragmentation, computational reduction, probabilistic instability, operational isolation, survivability reduction, environmental degradation, runtime participation collapse conditions, military degradation conditions, drone swarm fragmentation conditions, transportation disruption conditions, maritime communication instability conditions, or future equivalent contraction conditions.

A distributed survivability federation infrastructure may preserve continuity-preserving runtime participation continuity across partially fragmented distributed runtime participation infrastructures.

A runtime continuity synchronization governance infrastructure may govern synchronization relationships associated with continuity-preserving runtime participation continuity across distributed runtime participation infrastructures.

Synchronization governance relationships remain subordinated beneath continuity-governed survivability inheritance relationships rather than unrestricted synchronization propagation relationships.

A probabilistic runtime participation infrastructure may generate multiple probabilistic runtime participation states associated with uncertain operational environments.

The probabilistic runtime participation states may comprise partially inconsistent runtime participation states, probabilistically unstable runtime participation states, fragmented runtime participation states, incomplete runtime participation states, probabilistic reconstruction states, distributed uncertainty states, or future equivalent probabilistic runtime participation structures.

A probabilistic runtime participation subordination infrastructure prevents unrestricted probabilistic runtime participation regeneration from independently determining continuity-preserving runtime participation existence.

Artificial intelligence-generated runtime participation states remain non-authoritative with respect to continuity-preserving runtime participation existence determination.

Generated probabilistic runtime participation states remain subordinated beneath continuity-governed survivability admissibility relationships, authoritative continuity inheritance relationships, anchored continuity-preserving runtime participation relationships, distributed continuity governance relationships, runtime continuity inheritance relationships, survivability lineage relationships, and continuity-preserving runtime participation continuity relationships.

A continuity-governed survivability lineage infrastructure may preserve survivability lineage relationships associated with continuity-preserving runtime participation continuity.

A continuity-preserving operational restoration infrastructure may restore continuity-preserving runtime participation continuity following degraded runtime participation conditions, fragmented runtime participation conditions, distributed runtime participation interruptions, communication isolation conditions, operational contraction conditions, probabilistic instability conditions, or survivability degradation conditions.

Operational restoration relationships remain subordinated beneath continuity-governed survivability admissibility relationships and authoritative continuity inheritance relationships.

A distributed military survivability-oriented runtime participation environment may comprise mobile operational infrastructures, distributed edge runtime infrastructures, disconnected operational infrastructures, probabilistic operational infrastructures, communication infrastructures, sensor infrastructures, multi-bearer communication infrastructures, and continuity-governed survivability infrastructures operating across degraded operational conditions.

A first operational runtime participation node may become communication-isolated due to degraded battlefield communication conditions.

A second operational runtime participation node may remain partially operational while operating with incomplete runtime participation visibility.

A third operational runtime participation node may become temporarily disconnected from distributed survivability federation infrastructures.

Previously admitted continuity-preserving runtime participation states associated with authoritative continuity inheritance relationships remain preserved within continuity-governed survivability inheritance infrastructures.

Generated runtime participation states produced during degraded operational conditions remain subject to continuity-governed survivability admissibility relationships before becoming continuity-preserving runtime participation states.

Generated runtime participation states failing survivability admissibility relationships are prevented from becoming operationally participatory continuity-preserving runtime participation states even when probabilistic runtime participation confidence values exceed predefined probabilistic thresholds.

When distributed operational infrastructures become reconstructably available, survivability-preserving reconstruction relationships reconstruct admissibly inherited continuity-preserving runtime participation continuity from previously admitted continuity-preserving runtime participation states preserved within anchored continuity-preserving runtime participation infrastructures.

A distributed drone operational environment may comprise multiple distributed drone runtime participation infrastructures operating across fragmented communication conditions, probabilistic operational conditions, degraded positioning conditions, disconnected operational conditions, and dynamic survivability conditions.

One or more drone runtime participation infrastructures may become disconnected from distributed drone runtime participation continuity infrastructures.

Continuity-preserving runtime participation continuity associated with previously admitted continuity-preserving runtime participation states remains survivability-preserved through continuity-governed survivability inheritance relationships.

Distributed drone runtime participation continuity therefore remains governed through continuity inheritance relationships rather than unrestricted probabilistic drone runtime regeneration relationships.

A maritime survivability-oriented runtime participation environment may comprise distributed maritime runtime participation infrastructures operating across unstable communication environments, distributed vessel environments, probabilistically unstable operational conditions, heterogeneous runtime participation infrastructures, disconnected maritime operational conditions, and continuity-governed survivability infrastructures.

Continuity-preserving runtime participation continuity remains preserved through continuity inheritance relationships associated with previously admitted continuity-preserving runtime participation states even when maritime runtime participation infrastructures become communication-constrained or partially disconnected.

A survivability-oriented runtime continuity infrastructure may operate across multiple communication bearer infrastructures comprising Wi-Fi infrastructures, mesh communication infrastructures, edge communication infrastructures, distributed communication infrastructures, wireless communication infrastructures, wired communication infrastructures, satellite communication infrastructures, optical communication infrastructures, acoustic communication infrastructures, industrial communication infrastructures, military communication infrastructures, transportation communication infrastructures, maritime communication infrastructures, or future equivalent communication infrastructures.

Continuity-preserving runtime participation continuity remains survivability-governed through continuity inheritance relationships despite communication bearer transitions, bearer degradation conditions, bearer replacement conditions, communication instability conditions, or distributed survivability redistribution conditions.

A continuity-governed survivability restoration environment may comprise one or more human-authorized survivability restoration infrastructures configured to authorize restoration-associated continuity-preserving runtime participation continuity.

Human-authorized survivability restoration relationships remain subordinated beneath continuity-governed survivability admissibility relationships and authoritative continuity inheritance relationships.

Restored runtime participation states therefore remain continuity-governed survivability-preserving runtime participation states rather than unrestricted probabilistic runtime regeneration states.

1. A survivability-oriented runtime continuity system comprising:
a survivability-oriented runtime continuity architecture configured to sustain continuity-preserving runtime participation across degraded runtime participation conditions;
a distributed continuity governance architecture configured to maintain continuity-preserving runtime participation across fragmented distributed runtime participation environments;
a continuity collapse prevention architecture configured to constrain operational fragmentation associated with unrestricted probabilistic runtime recomputation;
a runtime continuity inheritance architecture configured to maintain continuity-preserving runtime participation across runtime participation transitions;
a reconstructable survivability architecture configured to reconstruct continuity-preserving runtime participation from previously admitted continuity-governed runtime participation structures;
an anchored continuity preservation architecture configured to maintain admissibly validated continuity-preserving runtime participation states as authoritative continuity inheritance structures; and
a probabilistic runtime participation subordination architecture configured to subordinate unrestricted probabilistic runtime participation regeneration beneath continuity-governed survivability inheritance determination;
wherein stable runtime participation existence is maintained through continuity-governed survivability inheritance rather than unrestricted probabilistic runtime regeneration;
wherein continuity-preserving runtime participation is continuity-inherited from previously admitted continuity-governed runtime participation structures;
wherein authoritative continuity inheritance structures govern admissibility of continuity-preserving runtime participation;
wherein continuity-preserving runtime participation is inherited from anchored continuity-preserving runtime participation states operating as authoritative survivability inheritance structures;
wherein distributed runtime participation continuity remains continuity-governed across heterogeneous distributed runtime participation environments;
wherein reconstructable survivability restoration maintains continuity-preserving runtime participation across degraded runtime participation conditions; and
wherein continuity collapse prevention constrains unrestricted probabilistic runtime participation divergence associated with fragmented distributed runtime participation environments.

2. The system of claim 1, wherein the survivability-oriented runtime continuity architecture maintains admissible continuity-preserving runtime participation during degraded runtime participation conditions.

3. The system of claim 1, wherein the distributed continuity governance architecture maintains distributed continuity-preserving runtime participation across fragmented communication environments.

4. The system of claim 1, wherein the continuity collapse prevention architecture constrains unrestricted probabilistic runtime participation regeneration associated with continuity fragmentation conditions.

5. The system of claim 1, wherein the runtime continuity inheritance architecture maintains continuity-preserving runtime participation inheritance across distributed runtime participation transitions.

6. The system of claim 1, wherein the reconstructable survivability architecture reconstructs admissible continuity-preserving runtime participation from previously admitted continuity-governed runtime participation structures.

7. The system of claim 1, wherein continuity-preserving runtime participation is maintained during heterogeneous communication carrier participation conditions.

8. The system of claim 1, wherein continuity-preserving runtime participation inheritance is maintained across runtime participation contraction conditions.

9. The system of claim 1, wherein admissibly validated continuity-preserving runtime participation states are maintained as anchored authoritative continuity inheritance structures associated with survivability-governed runtime participation continuity.

10. A survivability-oriented runtime continuity method comprising:
maintaining continuity-preserving runtime participation across degraded runtime participation conditions;
maintaining distributed continuity-preserving runtime participation across fragmented distributed runtime participation environments;
constraining unrestricted probabilistic runtime participation regeneration associated with operational fragmentation conditions;
maintaining runtime continuity inheritance across runtime participation transitions;
reconstructing continuity-preserving runtime participation from continuity-governed runtime participation structures;
maintaining admissibly validated continuity-preserving runtime participation states as authoritative continuity inheritance structures; and
subordinating unrestricted probabilistic runtime participation regeneration beneath continuity-governed survivability inheritance determination;
wherein stable runtime participation existence is maintained through continuity-governed survivability inheritance rather than unrestricted probabilistic runtime regeneration;
wherein authoritative continuity inheritance structures govern admissibility of continuity-preserving runtime participation;
wherein continuity-preserving runtime participation is inherited from anchored continuity-preserving runtime participation states operating as authoritative survivability inheritance structures;
wherein reconstructable survivability restoration maintains continuity-preserving runtime participation across degraded runtime participation conditions; and
wherein distributed runtime participation continuity remains continuity-governed across heterogeneous distributed runtime participation environments.

11. The method of claim 10, wherein maintaining distributed continuity-preserving runtime participation includes maintaining continuity-preserving runtime participation across heterogeneous communication carrier environments.

12. The method of claim 10, wherein constraining unrestricted probabilistic runtime participation regeneration reduces operational fragmentation associated with degraded runtime participation conditions.

13. The method of claim 10, wherein reconstructing continuity-preserving runtime participation includes reconstructing admissible continuity-preserving runtime participation from previously admitted continuity-governed runtime participation structures.

14. The method of claim 10, wherein runtime continuity inheritance maintains operational identity continuity inheritance across distributed runtime participation transitions.

15. The method of claim 10, wherein survivability-governed runtime participation continuity remains continuity-governed during fragmented distributed runtime participation conditions.

16. A survivability-oriented runtime continuity structure comprising:
a continuity-governed survivability preservation structure configured to maintain continuity-preserving runtime participation across distributed runtime participation environments;
a fragmented runtime continuity preservation structure configured to maintain continuity-preserving runtime participation during degraded runtime participation conditions;
a reconstructable continuity inheritance structure configured to reconstruct continuity-preserving runtime participation from previously admitted continuity-governed runtime participation structures;
a probabilistic runtime participation subordination structure configured to constrain unrestricted probabilistic runtime regeneration beneath continuity-governed survivability inheritance determination; and
an anchored survivability continuity structure configured to maintain admissibly validated continuity-preserving runtime participation states as authoritative continuity inheritance structures;
wherein stable runtime participation existence is maintained through survivability-oriented continuity inheritance relationships;
wherein authoritative continuity inheritance structures govern admissibility of continuity-preserving runtime participation;
wherein continuity-preserving runtime participation is inherited from anchored continuity-preserving runtime participation states operating as authoritative survivability inheritance structures;
wherein reconstructable survivability restoration maintains continuity-preserving runtime participation across degraded runtime participation conditions; and
wherein unrestricted probabilistic runtime participation regeneration remains subordinated beneath continuity-governed survivability inheritance determination.

17. The structure of claim 16, wherein the continuity-governed survivability preservation structure maintains continuity-preserving runtime participation across heterogeneous distributed runtime participation infrastructures.

18. The structure of claim 16, wherein the fragmented runtime continuity preservation structure maintains admissible continuity-preserving runtime participation during distributed operational degradation conditions.

19. The structure of claim 16, wherein the reconstructable continuity inheritance structure reconstructs continuity-preserving runtime participation from continuity-governed runtime participation inheritance structures.

20. The structure of claim 16, wherein admissibly validated continuity-preserving runtime participation states are maintained as anchored authoritative survivability continuity inheritance structures associated with continuity-preserving runtime participation continuity.
